(19) United States
(12) Patent Application Publication
(10) Pub. No.: US 2022/0349066 A1
(43) Pub. Date: Nov. 3, 2022

(54) Non-Noble Metal-Nitride Based Electrocatalysts for High-Performance Seawater Splitting

(71) Applicant: University of Houston System, Houston, TX (US)

(72) Inventors: Zhifeng REN, Pearland, TX (US); Luo YU, Houston, TX (US); Shuo CHEN, Houston, TX (US); Ying YU, Wuhan (CN)

(73) Assignee: University of Houston System, Houston, TX (US)

(21) Appl. No.: 17/633,075

(22) PCT Filed: Aug. 14, 2020
(86) PCT No.: PCT/US2020/046521

§ 371 Date: Feb. 4, 2022

Related U.S. Application Data
(60) Provisional application No. 62/916,400, filed on Oct. 17, 2019.
(60) Provisional application No. 62/887,442, filed on Aug. 15, 2019.

(51) Int. Cl. C25B 1/04; C25B 11/031; C25B 11/054; C25B 11/061; C25B 11/075; C25B 5/00

(52) U.S. Cl. CPC C25B 1/04; C25B 11/031; C25B 11/054; C25B 11/061; C25B 11/075; C25B 5/00

(57) ABSTRACT

A stable three-dimensional core-shell metal-nitride catalyst consisting of NiFeN nanoparticles decorated on NiMoN nanorods supported on porous Ni foam (NiMoN@NiFeN), which functions as an oxygen evolution reaction catalyst for alkaline seawater electrolysis. It yields large current densities of 500 and 1000 mA cm⁻² at overpotentials of 369 and 398 mV, respectively, in alkaline natural seawater at 25° C. Combined with an efficient hydrogen evolution reaction catalyst of NiMoN nanorods, current densities of 500 and 1000 mA cm⁻² at low voltages of 1.608 and 1.709 V, respectively are achieved for overall alkaline seawater splitting at 60° C.

### CROSS-REFERENCE TO RELATED APPLICATIONS

The present application is a 35 U.S.C. § 371 national stage application of PCT/US2020/046521 filed Aug. 14, 2020, which claims priority to U.S. Provisional Patent Application No. 62/887,442, filed Aug. 15, 2019 and U.S. Provisional Patent Application No. 62/916,400, filed Oct. 17, 2019, the entire contents of each being hereby incorporated herein by reference for all purposes.

### TECHNICAL FIELD

This disclosure relates to a non-noble metal-nitride based electrocatalyst, wherein in some embodiments the electrocatalyst is used for high-performance seawater splitting, wherein in some further embodiments the electrocatalyst in used in order to produce clean hydrogen energy; seawater desalination; and aid in environmental remediation.

### BACKGROUND

Seawater is one of the most abundant natural resources on our planet and accounts for 96.5% of the world's total water resources. Direct electrolysis of seawater rather than freshwater is highly significant, especially for the arid zones, since this technology not only stores clean energy, but also produces fresh drinking water when H₂ is used for electrical or thermal energy generation. Nevertheless, the implementation of seawater splitting remains highly challenging, especially for the anodic reaction.

Thus, the major challenge in seawater splitting is the chlorine evolution reaction (CER) on the anode due to the existence of chloride anions (˜0.5 M) in seawater, which would compete with the oxygen evolution reaction (OER). For the CER in alkaline media, chlorine would further react with OH⁻ for hypochlorite formation with an onset potential of about 490 mV higher than that of OER, and thus highly active OER catalysts are required to deliver large current densities (500 and 1000 mA cm⁻²) at overpotentials well below 490 mV for hypochlorite formation. Another bottleneck hindering the progress of seawater splitting is the formation of insoluble precipitates, such as magnesium hydroxide, on the electrode surface, which may poison the OER and hydrogen evolution reaction (HER) catalysts. To alleviate this issue, catalysts possessing large surface areas with numerous active sites are more favorable.

In addition to the above mentioned issues, the aggressive chloride anions in seawater also corrode the electrodes, further restricting the development of seawater splitting. Because of these obstacles, only a few studies on electrocatalysts for seawater splitting have been reported, with limited progress made thus far. Recently, an anode catalyst composed of a nickel-iron hydroxide layer coated on a nickel sulfide layer for active and stable alkaline seawater electrolysis, in which a current density of 400 mA cm⁻² was achieved at 1.72 V for two-electrode electrolysis in 6 M KOH+1.5 M NaCl electrolyte at 80° C. was developed.

Other non-precious electrocatalysts, including transition metal hexacyanometallate, cobalt selenide, cobalt borate, and cobalt phosphate, have been well studied for OER in NaCl containing electrolytes, but the overpotentials needed to deliver large current densities (500 and 1000 mA cm⁻²) and are thus much higher than 490 mV, not to mention the activity for overall seawater splitting.

Therefore, it is highly desirable to develop other robust and inexpensive electrocatalysts to expedite the seawater splitting process (especially for OER at large current densities) in order to address large-scale seawater electrolysis. The implementation of seawater electrolysis thus requires robust and efficient electrocatalysts that can sustain seawater splitting without chloride corrosion of system anodes.

The non-noble metal-nitride based electrocatalysts herein disclosed herein thus address such needs in the art for high-performance seawater splitting as described above.

### BRIEF DESCRIPTION OF THE DRAWINGS

For a more complete understanding of the present disclosure, reference will now be made to the accompanying drawings/figures in which:

FIG. 1: depicts the synthesis and microscopic characterization of an embodiment of an as-prepared NiMoN@NiFeN catalyst as disclosed herein: a, depicts a schematic illustration of synthesis procedures for the self-supported 3D core-shell NiMoN@NiFeN catalyst. b, depicts SEM images of NiMoN, and (c,d) depict SEM images of NiMoN@NiFeN at different magnifications. e,f, depict TEM images of NiMoN@NiFeN core-shell nanorods at different magnifications. g, depicts an HRTEM image, h depicts an SAED pattern, i, depicts an EDS line scan, and j, depicts a dark field scanning transmission electron microscopy (DF-STEM) image and corresponding elemental mapping of the NiMoN@NiFeN catalyst as disclosed herein.

FIG. 2: depicts the structural characterization of an embodiment of an embodiment of the disclosed catalysts by: a) XRD, and b, XPS survey, and c,d,e,f, high-resolution XPS of (c) Ni 2p, (d) Fe 2p, (e) Mo 3d, and (f) N 1s of the NiMoN, NiFeN, and NiMoN@NiFeN catalysts.

FIG. 3: depicts characterization data for embodiments of oxygen and hydrogen evolution catalysts as disclosed herein: a, OER polarization curves in 1 M KOH, and b, corresponding Tafel plots of different catalysts; c, OER chronoamperometry curves of NiMoN@NiFeN at overpotentials of 277 and 337 mV in 1 M KOH with inset: CV curves of NiMoN@NiFeN before and after the stability test; d, HER polarization curves tested in 1 M KOH, and e, corresponding Tafel plots of different catalysts; f, HER chronoamperometry curves of NiMoN at overpotentials of 56 and 127 mV in 1 M KOH, with inset: LSV curves of NiMoN before and after the stability test; g, OER and HER polarization curves of NiMoN@NiFeN and NiMoN, respectively, in different electrolyte; and h, comparison of the overpotentials at 100, 500, and 1000 mA cm⁻² for NiMoN@NiFeN (OER) and NiMoN (HER) in different electrolytes.

FIG. 4: shows an overall seawater splitting performance of embodiments of electrodes disclosed herein; a, depicts a schematic diagram of an overall seawater splitting electrolyzer with NiMoN and NiMoN@NiFeN as the cathode and anode, respectively; b, depicts polarization curves of NiMoN and NiMoN@NiFeN coupled catalysts in a two-electrode electrolyzer tested in different electrolytes under different temperatures; c, depicts comparison between the amount of collected and theoretical gaseous products (H₂ and O₂) by the two-electrode electrolyzer at a constant current density of 100 mA cm⁻² in 1 M KOH+0.5 M NaCl at 25° C.; d, depicts durability tests of the electrolyzer at constant current densities of 100 and 500 mA cm⁻² in different electrolytes at 25° C.; e, depicts a schematic of the principle for power generation between the hot and cold sides of a TE device; and f, depicts real-time dynamics of current densities for the electrolyzer in 1 M KOH+0.5 M NaCl at 25° C. driven by a TE device when the temperature gradient (ΔT) between its hot and cold sides is 40, 50, 60, and 40° C.

FIG. 5. depicts material characterization during and after OER to study OER active sites of embodiments of catalysts as disclosed herein: a, b, depict TEM images of NiMoN@NiFeN core-shell nanorods at different magnifications after OER tests; c, depicts a HRTEM image, and d, depicts a DF-STEM image and corresponding elemental mapping of the NiMoN@NiFeN catalyst after OER tests. High-resolution XPS of e, Ni 2p and f, Fe 2p of NiMoN@NiFeN after OER tests in comparison with those before the OER tests are further depicted; g, depicts in situ Raman spectra of the NiMoN@NiFeN catalyst at various potentials for the OER process.

FIG. 6 (a-c) depict SEM images of the commercial Ni foam, as disclosed herein.

FIG. 7 depicts (a) XRD pattern of embodiments of NiMoO₄ on Ni foam. (b-d) SEM images of NiMoO₄ nanorods on Ni foam at different magnifications, as disclosed herein.

FIG. 8 (a-b) depict SEM images of embodiments of NiMoN nanorods on Ni foam at different magnifications as disclosed herein.

FIG. 9 (a-b) depict SEM images of embodiments of NiFeN nanoparticles on Ni foam at different magnifications, as disclosed herein.

FIG. 10 depicts SEM images of embodiments of NiMoN@NiFeN core-shell nanorods prepared with different loading amounts of NiFeN nanoparticles by controlling the concentration of NiFe precursors. (a1-a3) 0.1 g ml⁻¹; (b1-b3) 0.25 g ml⁻¹; (c1-c3) 0.5 g ml⁻¹; and (d1-d3) 0.75 g ml⁻¹, as disclosed herein.

FIG. 11 depicts calibration of the Hg/HgO reference electrode with respect to RHE in 1 M KOH, as disclosed herein.

FIG. 12 depicts CV backward scan polarization curves of different electrodes tested in 1 M KOH at room temperature, as disclosed herein.

FIG. 13 depicts OER CV polarization curves of different catalysts tested in 1 M KOH at room temperature without IR compensation, as disclosed herein.

FIG. 14 depicts (a) OER CV polarization curves of different catalysts tested in 1 M KOH at room temperature with iR compensation. Partial CV curves of (b) NiFeN, (c) NiMoN, and (d) NiMoN@NiFeN from (a) selected to study the redox behaviors of the metal-nitride catalysts, as disclosed herein.

FIG. 15 depicts OER polarization curves (1 M KOH, 25° C.) of embodiments of NiMoN@NiFeN catalysts prepared with different loading amounts of NiFeN nanoparticles by controlling the concentration of NiFe precursors, as disclosed herein.

FIG. 16 (a-d) depict SEM images of embodiments of NiMoN@NiFeN core-shell nanorods after OER stability tests, as disclosed herein.

FIG. 17 depicts CV curves of (a) NiFeN, (b) NiMoN, and (c) NiMoN@NiFeN at scan rates ranging from 10 mV s⁻¹ to 60 mV s⁻¹ with an interval point of 10 mV s⁻¹.

FIG. 18 depicts linear fitting of the capacitive currents of the catalysts vs. the scan rates to calculate double-layer capacitance (C_{dl}).

FIG. 19 depicts OER polarization curves in 1 M KOH at 25° C. for embodiments of catalysts normalized by the electrochemical active surface area (ECSA), as disclosed herein.

FIG. 20 depicts EIS Nyquist plots of embodiments of different catalysts as disclosed herein.

FIG. 21 depicts optical images of (a) the two electrolytes, and (b) the NiMoN@NiFeN sample before and after seawater electrolysis, as disclosed herein;

FIG. 22 depicts EDX spectra of the NiMoN@NiFeN catalyst (a) before, and (b) after seawater electrolysis, as disclosed herein.

FIG. 23 depicts polarization curves of NiMoN@NiFeN∥NiMoN for overall seawater splitting (Electrolyte: 1 M KOH+Seawater, temperature: 25° C.) with and without iR compensation, as disclosed herein.

FIG. 24 depicts polarization curves of (a) NiMoN@NiFeN for OER, (b) NiMoN for HER, and (c) NiMoN@NiFeN∥NiMoN for overall seawater splitting using natural seawater as the electrolyte at 25° C., as disclosed herein.

FIG. 25 depicts experimental measurements of H₂ and O₂ amounts produced by our water electrolyzer. (a) depicts a chronopotentiometric curve of the NiMoN@NiFeN∥NiMoN electrolyzer for overall seawater splitting at a constant current density of 100 mA cm⁻² for the GC tests. Electrolyte: 1 M KOH+0.5 M NaCl; temperature: 25° C. (b) GC signals of H₂ and O₂ during 90 min GC testing with detection every 10 min.

FIG. 26 depicts (a,b) TEM images at different magnifications, and (c) DF-STEM image and corresponding elemental mapping of NiMoN@NiFeN after 100 h seawater electrolysis at 500 mA cm⁻² in 1 M KOH+Seawater, as disclosed herein.

FIG. 27 depicts polarization curve after iR compensation, and (b) durability test of the NiMoN@NiFeN∥NiMoN electrolyzer at a constant current density of 100 mA cm⁻² in 6 M KOH+Seawater at 25° C., as disclosed herein.

FIG. 28. Depicts a photograph showing the O₂ and H₂ bubbles produced from overall seawater splitting driven by a 1.5 V AA battery as disclosed herein, electrolyte: 1 M KOH+0.5 M NaCl; temperature: 25° C.

FIG. 29 depicts high-resolution XPS of N 1s of NiMoN@NiFeN after OER test in comparison with that before OER test, as disclosed herein.

FIG. 30 depicts high-resolution XPS of (a) Ni 2p of NiO and Ni₂O₃, and (b) Fe 2p of FeSO₄ and Fe₂(SO₄)₃ for reference, as disclosed herein.

FIG. 31 depicts high-resolution XPS of O 1s of NiMoN@NiFeN after OER test in comparison with that before OER test, as disclosed herein.

FIG. 32 depicts optical images of (a) a post-OER NiMoN@NiFeN sample, and (b) a fresh NiMoN@NiFeN sample before and after 1-day of soaking in natural seawater, as disclosed herein.

### SUMMARY OF THE DISCLOSURE

In some embodiments, a three-dimensional core-shell transition metal-nitride (TMN) catalyst is disclosed that comprises a porous Ni foam support, nanorods comprising a first transition metal-nitride (TMN) material positioned on the porous Ni foam support; and nanoparticles comprising a second transition metal-nitride (TMN) material positioned on the nanorods wherein the catalyst functions as an oxygen evolution reaction catalyst. In another embodiment, the catalyst catalyzes alkaline seawater electrolysis.

In some embodiments of the three-dimensional core-shell transition metal-nitride (TMN) catalyst disclosed herein, the first transition metal-nitride (TMN) material is Ni₃N/Ni, NiMoN, NiFeN, NiCoN, CoFeN, or a combination thereof, in another embodiment of the catalyst the nanorod comprises one of Ni₃N/Ni, NiMoN, NiFeN, NiCoN, and CoFeN or a combination thereof, and in a further embodiment the nanorod comprises NiMoN.

In some embodiments of the three-dimensional core-shell transition metal-nitride (TMN) catalyst disclosed herein, the second transition metal-nitride (TMN) material is one of Ni₃N/Ni, NiMoN, NiFeN NiCoN, CoFeN, or a combination thereof; in another embodiment of the catalyst the nanorod comprises Ni₃N/Ni, NiMoN, NiFeN, NiCoN, CoFeN or a combination thereof. In some embodiments of the three-dimensional core-shell transition metal-nitride (TMN) catalyst disclosed herein, the nanoparticles comprise NiFeN. In an embodiment of the three-dimensional core-shell transition metal-nitride (TMN) catalyst disclosed herein, the catalyst comprises current densities of about 500 to about 1000 mA cm⁻² at overpotentials of between 369 and 398 mV, and in another embodiment the catalyst further comprises a hydrogen evolution catalyst, in a further embodiment the catalyst comprises current densities of about 500 to about 1000 mA cm⁻² at about 1.6 V and about 1.7V. In another embodiment, the nanorods comprise mesopores; in some embodiments the mesoporous pores are between 0.001 nm and 50 nm in diameter; and in further embodiments the mesopores comprise a surface roughness (Ra) of between 0.1 and 50. In a further embodiment t=of the catalyst, the nanorods comprise a scaffold, and wherein the scaffold comprises active edge sites for OER.

Disclosed herein in one embodiment is a method of making a three-dimensional core-shell transition metal-nitride (TMN) catalyst which comprises positioning a porous Ni foam support; forming nanorods on the support; soaking the nanorods in a precursor ink, and performing a nitridation of the nanorods to form a three-dimensional core-shell transition metal-nitride (TMN) catalyst, wherein the catalyst is a oxygen evolution reaction (OER) catalyst. In a further embodiment of the method the forming is by a hydrothermal method, the nanorods comprise NiMoN, the nanoparticles comprise NiFeN. Further, disclosed herein is a three-dimensional core-shell NiMoN@NiFeN catalyst which comprises a porous Ni foam support, NiMoN nanorods positioned on the porous Ni foam support; and NiFeN nanoparticles positioned on the NiMoN nanorods, wherein the NiMoN@NiFeN catalyst functions as an oxygen evolution reaction catalyst for alkaline seawater electrolysis. Disclosed herein in one embodiment is an oxygen evolution reaction (OER) catalyst for alkaline seawater electrolysis which comprises a three-dimensional core-shell metal-nitride catalyst (NiMoN@NiFeN), wherein the catalyst comprises NiFeN nanoparticles decorated on NiMoN nanorods, wherein the NiMoN nanorods are supported on a porous Ni foam support (NiMoN@NiFeN), which functions as an oxygen evolution reaction catalyst for alkaline seawater electrolysis. Disclosed in some embodiments is an oxygen evolution reaction (OER) catalyst for alkaline seawater electrolysis comprises a porous Ni foam support; NiMoN nanorods positioned on the porous Ni foam support; and NiFeN nanoparticles positioned on the NiMoN nanorods to form NiMoN@NiFeN wherein the NiMoN@NiFeN is a three-dimensional core-shell metal-nitride catalyst wherein the catalyst is an oxygen evolution reaction catalyst for alkaline seawater electrolysis.

Disclosed herein in some further embodiments is a three-dimensional core-shell NiMoN@NiFeN oxygen evolution reaction (OER) catalyst which comprises a porous Ni foam support, nanorods comprising NiMoN positioned on the porous Ni foam support; and NiFeN nanoparticles positioned on the nanorods, wherein the catalyst functions as an oxygen evolution reaction catalyst for alkaline seawater electrolysis.

The foregoing has outlined rather broadly certain of the features of the exemplary embodiments of the present invention in order that the detailed description that follows may be better understood. It should be appreciated by those skilled in the art that the conception and the specific embodiments disclosed may be readily utilized as a basis for modifying or designing other methods and structures for carrying out the same purposes of the invention that is claimed below.

### DETAILED DESCRIPTION OF DISCLOSED EXEMPLARY EMBODIMENTS

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques below, including the exemplary designs and implementations illustrated and described herein, but may be modified within the scope of the appended claims along with their full scope of equivalents.

The following discussion is directed to various exemplary embodiments of the disclosure. One skilled in the art will understand that the following description has broad application, and the discussion of any embodiment is meant only to be exemplary of that embodiment, and that the scope of this disclosure, including the claims set out below, is not limited to that embodiment.

The drawing figures are not necessarily to scale. Certain features and components herein may be shown exaggerated in scale or in somewhat schematic form and some details of conventional elements may be omitted in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first component or device couples to a second, that connection may be through a direct engagement between the two components or devices, or through an indirect connection that is made via other intermediate devices and connections. As used herein, the term “about,” when used in conjunction with a percentage or other numerical amount, means plus or minus 10% of that percentage or other numerical amount. For example, the term “about 80%,” would encompass 80% plus or minus 8%. As used herein the terminology instrument, apparatus, and device may be used interchangeably. All papers, publications and other references cited herein are hereby incorporated by reference in their entirety:

### Overview

Disclosed herein are embodiments of three-dimensional core-shell transition metal-nitride (TMN) catalyst and methods of making such three-dimensional core-shell transition metal-nitride (TMN) catalysts.

Transition metal-nitride (TMN) is highly corrosion-resistant, electrically conductive, and mechanically strong, and a very promising candidate for electrolytic seawater splitting. Recent studies on Ni₃N/Ni, NiMoN, and Ni—Fe—Mo trimetallic nitride catalysts have established TMN-based materials to be efficient non-noble metal electrocatalysts for freshwater splitting in alkaline media (1 M KOH). Considering the need for catalysts with large surface areas and high-density active sites for seawater splitting, herein the design and synthesis of a three-dimensional (3D) core-shell TMN-based OER electrocatalyst, in which NiFeN nanoparticles are uniformly decorated on NiMoN nanorods supported on porous Ni foam (NiMoN@NiFeN) for exceptional alkaline seawater electrolysis are disclosed.

The 3D core-shell catalyst yields large current densities of 500 and 1000 mA cm⁻² at overpotentials of 369 and 398 mV, respectively, for OER in 1 M KOH+natural seawater at 25° C. Deep studies show that in-situ evolved amorphous layers of NiFe oxide and NiFe oxy(hydroxide) on the anode surface are the active sites that not only responsible for the superior OER performance, but also contribute to the superior chlorine corrosion-resistance.

Additionally, the integrated 3D core-shell TMN nanostructures with multiple levels of porosity offer numerous active sites, efficient charge transfer, and rapid gaseous product releasing, which also account for the promoted OER performance. An outstanding two-electrode seawater electrolyzer has subsequently been fabricated by pairing embodiments of the disclosed OER catalyst with another efficient HER catalyst of NiMoN, wherein the current densities of 500 and 1000 mA cm−2 are achieved at record low voltages of 1.608 and 1.709 V, respectively, for overall alkaline seawater splitting at 60° C., along with superior stability. Embodiments of the electrolyzer disclosed herein can be driven by an AA battery or a commercial thermoelectric module, demonstrating great potentials and flexibility utilizing broad power sources.

The implementation of seawater electrolysis thus requires robust and efficient electrocatalysts that can sustain seawater splitting without chloride corrosion of system anodes. Thus, disclosed herein is a three-dimensional core-shell metal-nitride catalyst consisting of NiFeN nanoparticles decorated on NiMoN nanorods supported on porous Ni foam (NiMoN@NiFeN), which serves as an eminently active and durable oxygen evolution reaction catalyst for alkaline seawater electrolysis. It yields large current densities of 500 and 1000 mA cm⁻² at overpotentials of 369 and 398 mV, respectively, in alkaline natural seawater at 25° C. Combined with an efficient hydrogen evolution reaction catalyst of NiMoN nanorods. Current densities of 500 and 1000 mA cm⁻² at record low voltages of 1.608 and 1.709 V, respectively, were achieved (as required for industrial application) for overall alkaline seawater splitting at 60° C., along with superior stability have been achieved by embodiments disclosed herein.

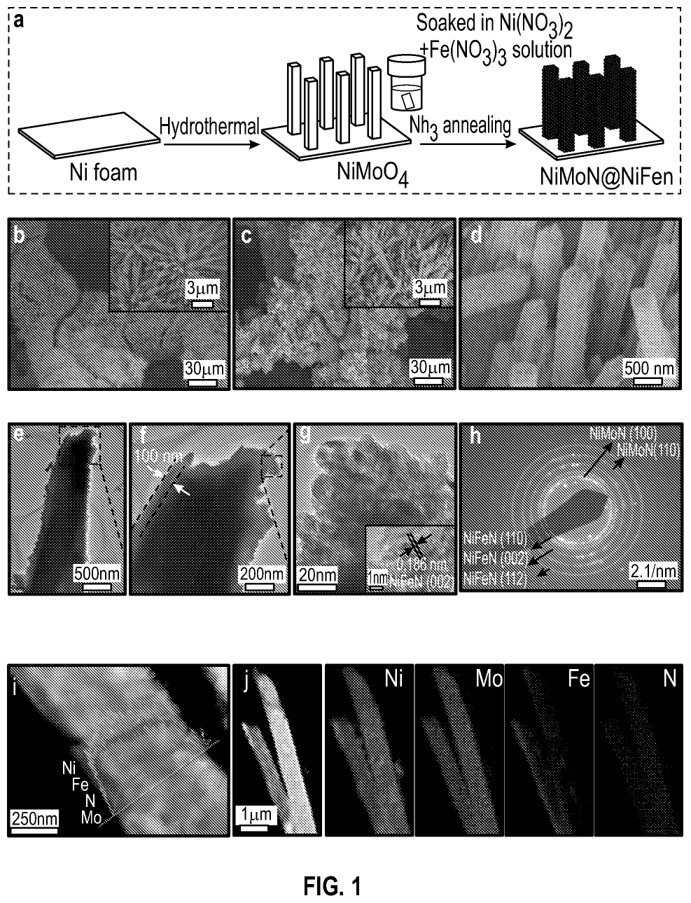

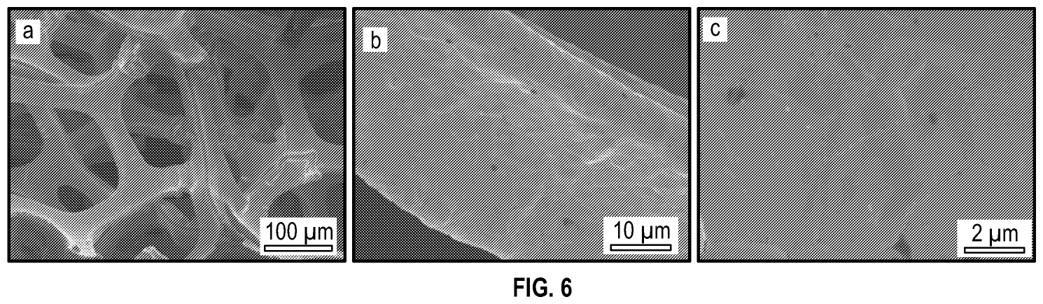

Electrocatalyst preparation and characterization: FIG. 1a depicts a schematic illustration of the synthesis procedures for the 3D core-shell NiMoN@NiFeN catalyst, wherein in some embodiments a commercial Ni foam (as depicted in FIG. 6) is used as a conductive support due to its high surface area, good electrical conductivity, and low cost.

NiMoO₄ nanorod arrays on Ni foam were first synthesized through a hydrothermal method, which was then soaked in a NiFe precursor ink and air-dried, followed by a one-step thermal nitridation.

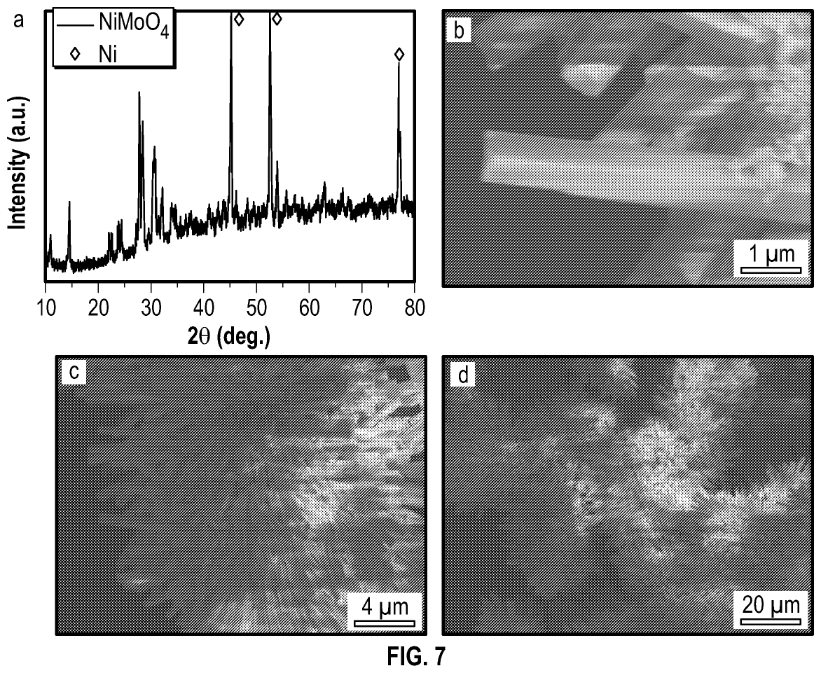

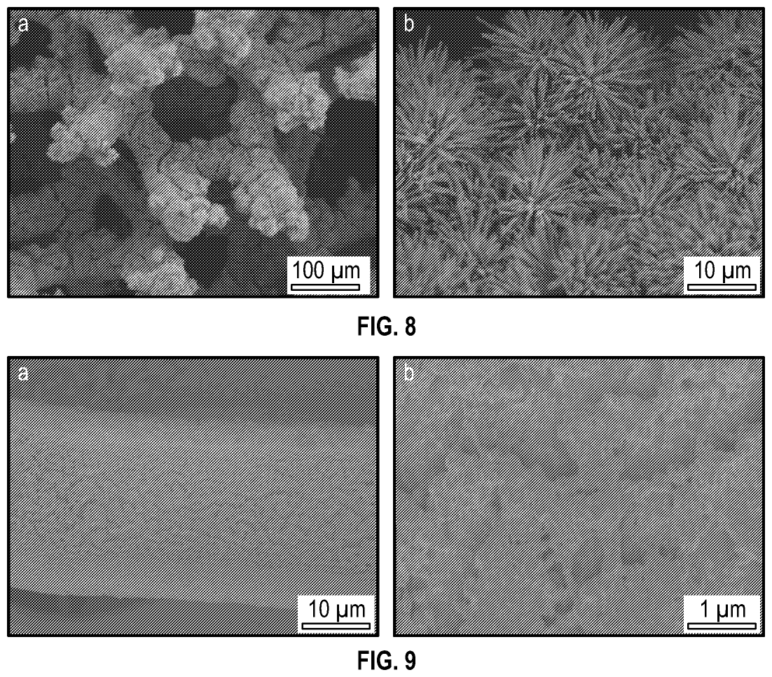

The stable construction and the hydrophilic nature of the NiMoO₄ nanorod arrays (FIG. 7(a-d)) facilitate the uniform coverage of the nanorods by the NiFe precursor ink. The pure NiMoN catalyst was prepared by nitridation of NiMoO₄ without soaking in precursor ink, and scanning electron microscopy (SEM) images show that numerous nanorods with smooth surfaces were uniformly and vertically grown on the surface of the Ni foam (FIG. 1b and its inset, FIG. 8).

After soaking in the precursor ink and thermal nitridation, the NiMoN@NiFeN shows a well-preserved nanorod morphology with rough and dense surfaces (FIG. 1c and its inset). The high-magnification SEM image in FIG. 1d clearly shows that the surfaces of the nanorods were decorated with many nanoparticles, forming a unique 3D core-shell nanostructure that offers an extremely large surface area with a large number of active sites even with the formation of insoluble precipitates during seawater electrolysis.

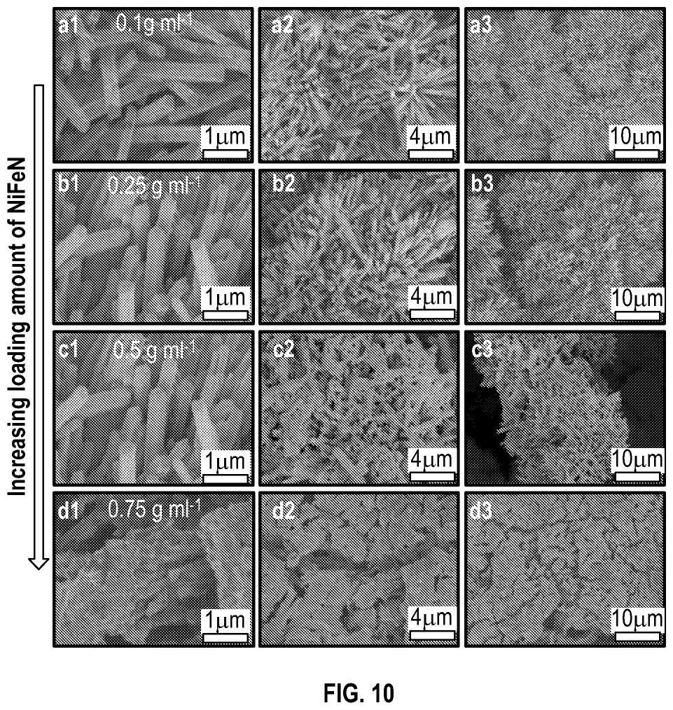

For comparison, pure NiFeN nanoparticles (FIG. 9) were also synthesized on the Ni foam by soaking bare Ni foam in the NiFe precursor ink, followed by thermal nitridation. Herein the morphology variation of NiMoN@NiFeN with different loading amounts of NiFeN nanoparticles were studied by controlling the concentration of NiFe precursor ink (FIG. 10). It was determined that the optimized concentration is 0.25 g ml-1, and is used herein unless otherwise indicated.

Transmission electron microscopy (TEM) images of NiMoN@NiFeN in FIGS. 1e and 1f further detail the desired core-shell morphology of the nanoparticle-decorated nanorods, showing that the thickness of the NiFeN shell is about 100 nm. FIG. 1g displays a high-resolution TEM (HRTEM) image taken from the tip of the NiMoN@NiFeN nanorod presented in FIG. 1f, showing that the NiFeN nanoparticles are highly mesoporous and interconnected with one another to form a 3D porous network, which is beneficial for seawater diffusion and gaseous product release.

The HRTEM image in the FIG. 1g inset reveals distinctive lattice fringes with interplanar spacings of 0.186 nm, which is assigned to the (002) plane of NiFeN. The selected area electron diffraction (SAED) pattern (FIG. 1h) recorded from the NiMoN@NiFeN core-shell nanorod exhibits apparent diffraction rings of NiMoN and NiFeN, confirming the existence of NiMoN and NiFeN phases. The energy dispersive X-ray spectroscopy (EDS) line scan result (FIG. 1i) and EDS mapping analysis (FIG. 1j) further verify the core-shell nanostructure, clearly showing that Mo and Fe are distributed in the central nanorod and edge nanoparticles, respectively, while Ni and N are homogeneously distributed throughout the entire core-shell nanorod.

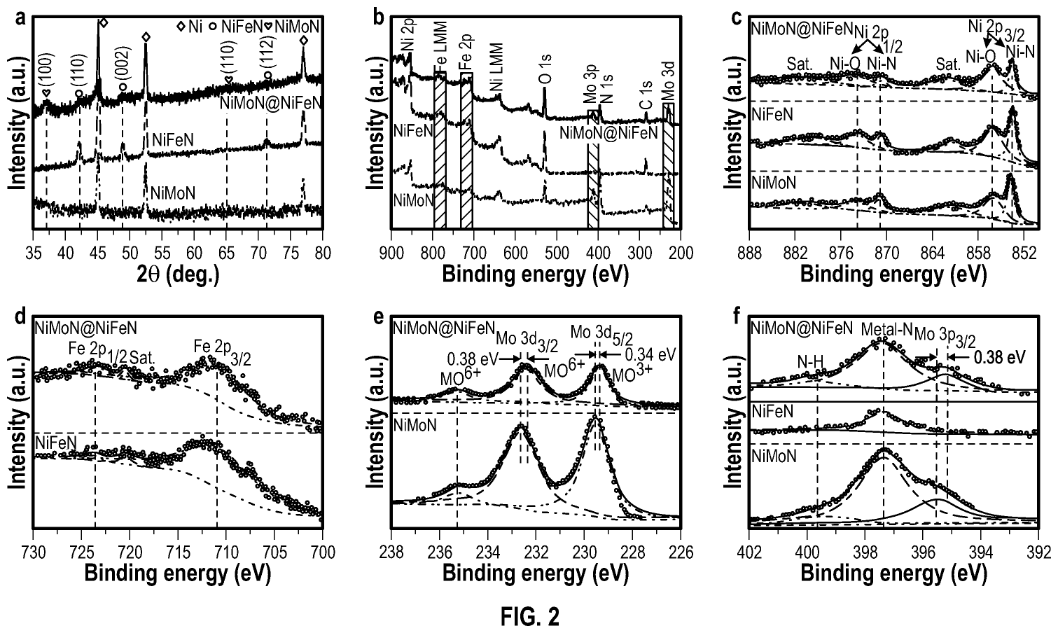

X-ray diffraction (XRD) and X-ray photoelectron spectroscopy (XPS) measurements were then conducted to study the chemical compositions and surface element states of the catalysts. Typical XRD patterns (FIG. 2a) reveal the formation of NiMoN and NiFeN compositions after corresponding thermal nitridation.

FIG. 2b shows the XPS survey spectra, demonstrating the presence of Ni, Mo, N in the NiMoN nanorods, Ni, Fe, N in the NiFeN nanoparticles, and Ni, Mo, Fe, N in the core-shell NiMoN@NiFeN nanorods. For the high-resolution XPS of Ni 2p of the three catalysts (FIG. 2c), the two peaks at 853.4 and 870.8 eV are attributed to the Ni 2p_{3/2} and Ni 2p_{1/2} of Ni species in Ni—N, respectively, while the peaks located at 856.3 and 873.9 eV are assigned to the Ni 2p_{3/2} and Ni 2p_{1/2} of the oxidized Ni species (Ni—O), respectively. The two additional peaks at 862.0 and 880.1 eV are the relevant satellite peaks (Sat.). The Fe 2p XPS of NiFeN and NiMoN@NiFeN in FIG. 2d show two peaks of Fe 2p_{3/2} and Fe 2p_{1/2} at 711.0 and 726.3 eV, respectively, as well as a small peak at 720.5 corresponding to the satellite-peak.

In FIG. 2e, the Mo 3d XPS of NiMoN and NiMoN@NiFeN show two valence states of Mo³⁺ and Mo⁶⁺. For NiMoN, the peak located at 229.6 eV (Mo 3d_{5/2}) is ascribed to Mo³⁺ in the metal-nitride, which is recognized to be active for HER.

The peaks at 232.7 (Mo 3d_{3/2}) and 235.3 eV are attributed to Mo⁶⁺ due to the surface oxidation of NiMoN. However, the two main peaks of Mo 3d_{5/2} (Mo³⁺) and Mo 3d_{3/2} (Mo⁶⁺) show an apparent negative shift in binding energy for the NiMoN@NiFeN, indicating the strong electronic interactions between NiMoN and NiFeN. For the N 1s XPS (FIG. 2f), the main peak is located at 397.4 eV, which is ascribed to the N species in metal-nitrides, and another peak at 399.6 eV originates from the incomplete reaction of NH₃. Additionally, the Mo 3p_{3/2} peak also appears for the NiMoN and NiMoN@NiFeN, and a negative shift in binding energy still exists for the NiMoN@NiFeN, which is in good agreement with the results in FIG. 2e.

### Oxygen and Hydrogen Evolution Catalysis:

The OER activity of embodiments of disclosed catalysts in 1 M KOH electrolyte were evaluated in freshwater at room temperature (25° C.). The benchmark IrO₂ catalyst on the Ni foam was also included for comparison. All data were measured after cyclic voltammetry (CV) activation and reported with IR compensation (85%).

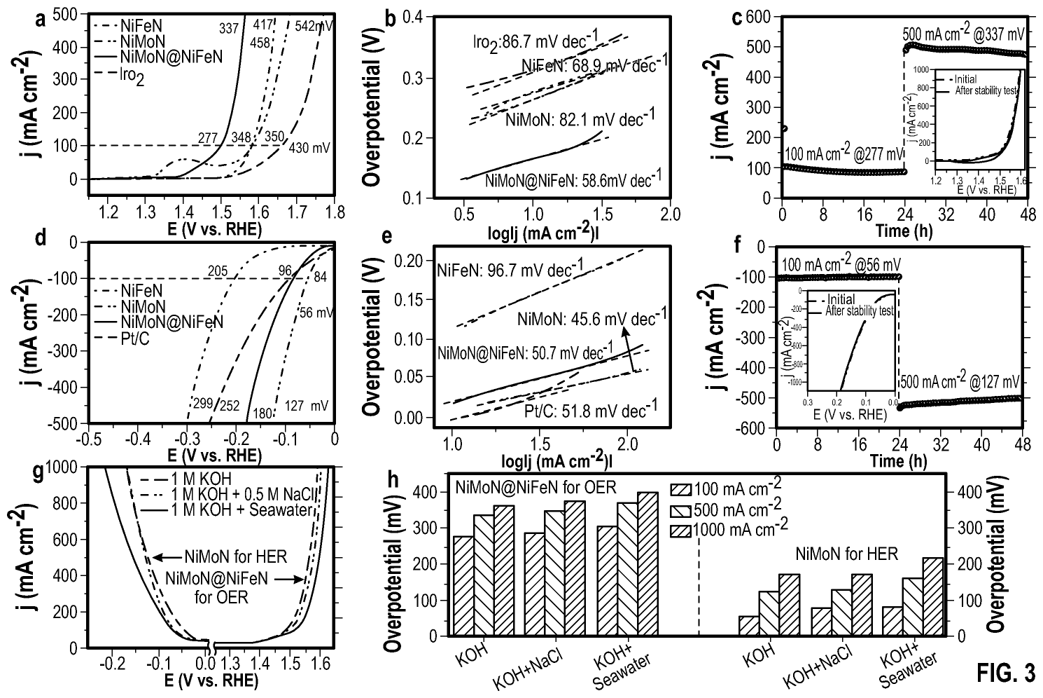

As the CV forward scan results in FIG. 3a show, embodiments of the 3D core-shell NiMoN@NiFeN catalyst exhibits significantly improved OER activity, which requires overpotentials as low as 277 and 377 mV to achieve current densities of 100 and 500 mA cm⁻², respectively, in comparison with those of NiFeN (348 and 417 mV), NiMoN (350 and 458 mV), and the benchmark IrO₂ electrodes (426 and 542 mV).

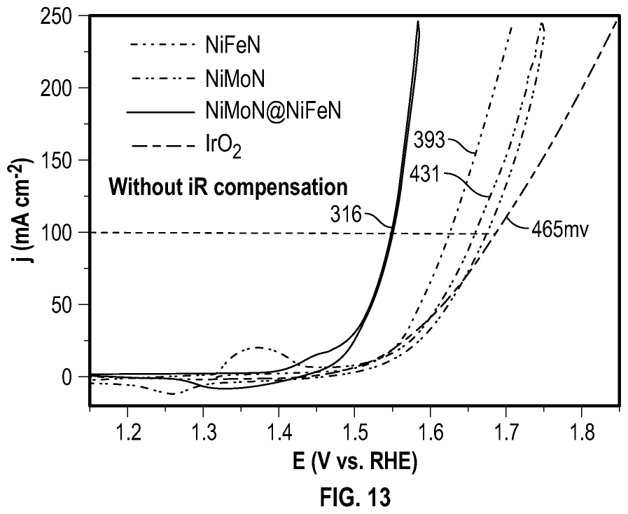

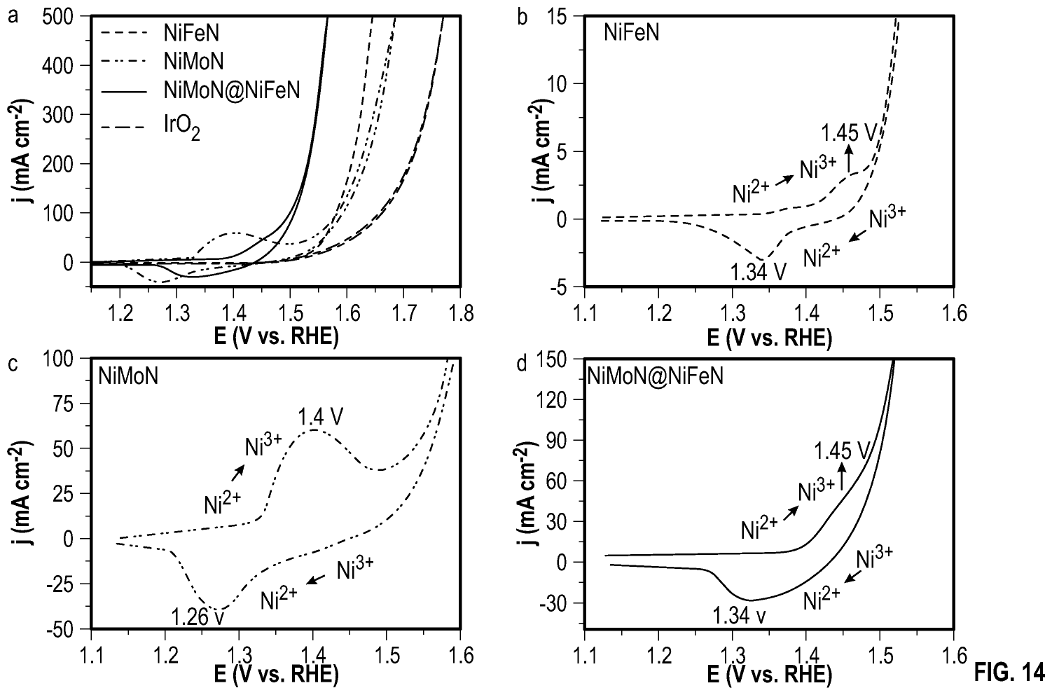

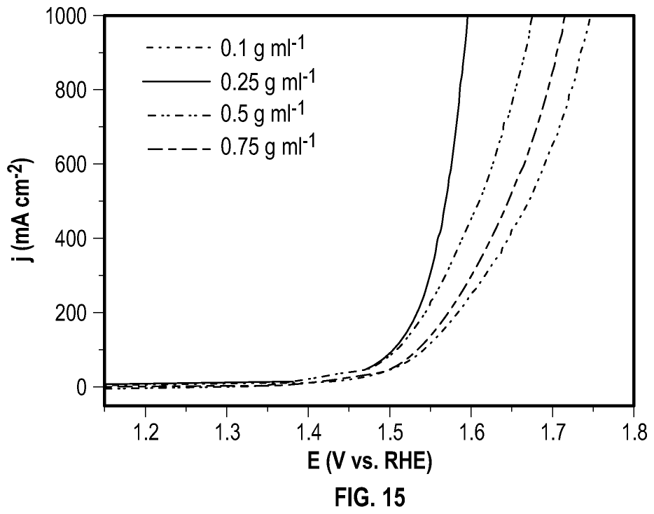

This performance is also superior to that of most non-precious OER catalysts in 1 M KOH (Table 1), including the recently reported ZnCo oxyhydroxide, Se-doped FeOOH, NiCoFe—MOF (metal-organic frameworks), and FeNiP/NCH (nitrogen-doped carbon hollow framework). The polarization curves of the CV backward scan, the CV without and with iR compensation are presented for comparison in FIGS. 12, 13, and 14a, respectively. We also investigated the redox behaviors of the different metal-nitride catalysts by analyzing their CV curves in the range of about 1.125˜1.525 V vs. RHE, and the results are displayed in FIGS. 14b-9d. In addition, the OER activity of other NiMoN@NiFeN catalysts with different loading amounts of NiFeN were also studied (FIG. 15), and an embodiment prepared with a precursor ink concentration of 0.25 g ml⁻¹ exhibits the highest OER activity. Tafel plots in FIG. 3b show that the NiMoN@NiFeN catalyst has a relatively smaller Tafel slope of 58.6 mV dec⁻¹ in comparison with that of the NiFeN (68.9 mV dec⁻¹), NiMoN (82.1 mV dec⁻¹), and IrO₂ electrodes (86.7 mV dec⁻¹), thus verifying its rapid OER catalytic kinetics.

Impressively, embodiments of the 3D core-shell NiMoN@NiFeN catalyst shows durability as well for OER in 1 M KOH electrolyte.

As presented in FIG. 3c, the current densities of 100 and 500 mA cm⁻² at constant overpotentials show negligible decrease over 48 h OER catalysis, and the CV polarization curves (inset of FIG. 3c) after the stability test remain almost the same as prior to the test.

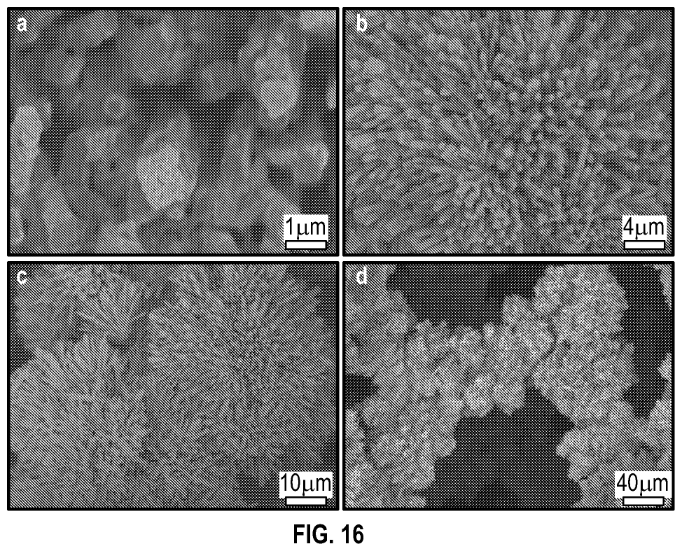

Moreover, SEM images after OER stability tests (FIG. 16) demonstrate high integrity of the 3D core-shell nanostructures of the NiMoN@NiFeN catalyst. Thus, the long-term robustness mostly originates from its integral 3D core-shell nanostructure with different levels of porosity, which benefits rapid gaseous product release, and the strong adhesion between the TMN catalysts and the Ni foam substrate.

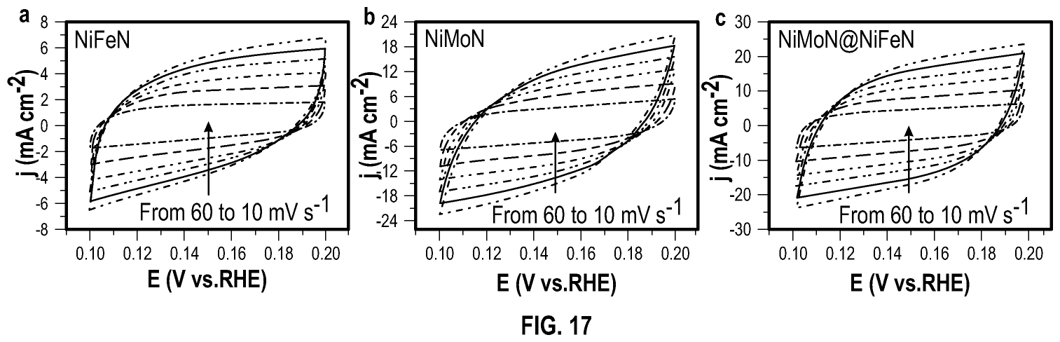

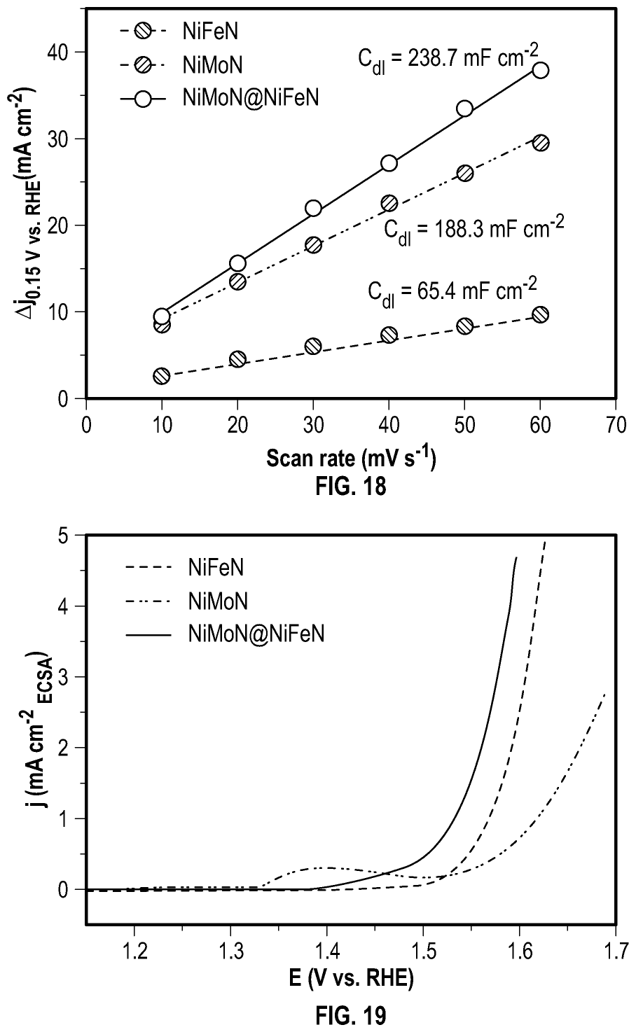

To investigate the origins of promoted OER activity in the NiMoN@NiFeN catalyst, the electrochemical active surface area (ECSA) for the different catalysts were calculated by double-layer capacitance (Cdl) from cyclic voltammetry (CV, FIG. 17) curves. The Cdl values of the NiMoN and NiMoN@NiFeN catalysts are as large as 188.3 and 238.7 mF cm−2 (FIG. 18), respectively, which are nearly 2.9 and 3.6 times that of the pure NiFeN nanoparticles (65.4 mF cm⁻²), respectively, demonstrating the highly improved ECSA and the increased number of active sites achieved by decorating NiFeN nanoparticles on the NiMoN nanorods to form a 3D core-shell nanoarchitecture, which benefits seawater adsorption and offers rich active sites for catalytic reactions.

The current density was further normalized by the ECSA, and the NiMoN@NiFeN catalyst shows better OER activity than that of NiFeN (FIG. 19), indicating that factors other than the ECSA may also contribute to the promoted OER activity.

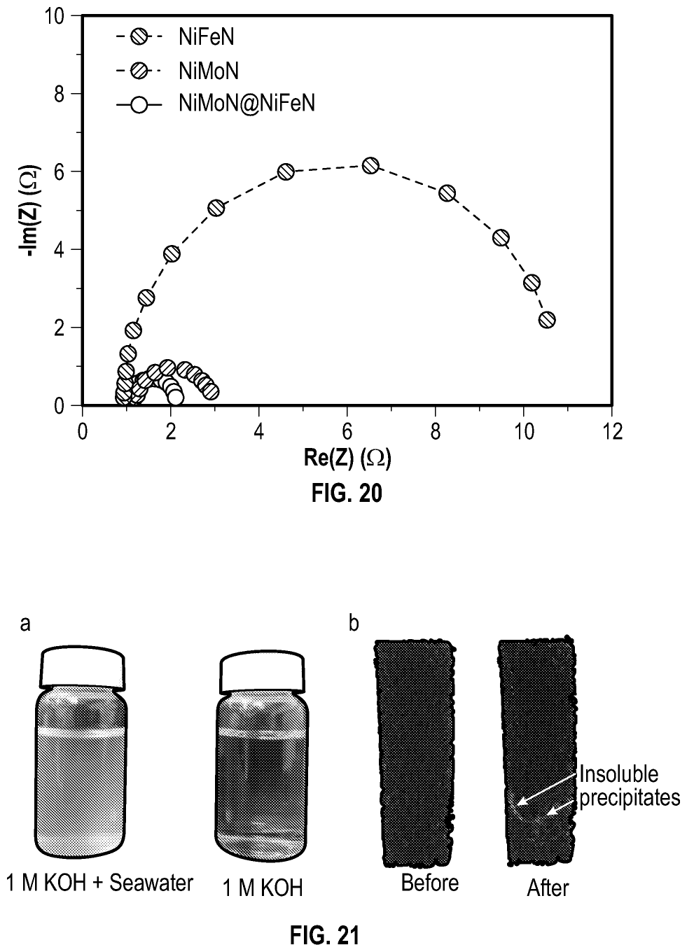

For the NiMoN@NiFeN core-shell catalyst, the highly conductive core of NiMoN nanorods and the robust contact between the NiFeN nanoparticles and NiMoN nanorods facilitate the charge transfer between the catalyst and electrolyte, as indicated by results from electrochemical impedance spectroscopy (EIS, FIG. 20), which shows that the charge-transfer resistance (Rct) of this 3D core-shell electrode is only 1.0Ω, significantly smaller than 9.6Ω of NiFeN.

Additionally, the NiMoN catalyst also has a small Rct of 1.7Ω, confirming its good electronic conductivity and fast charge transfer. Hence, the rational design of 3D core-shell TMN catalysts offers a large surface area and efficient charge transfer, both of which contribute to the improved OER activity.

To seek a good HER catalyst to combine with embodiments of the NiMoN@NiFeN catalyst for overall seawater splitting, HER performance of different catalysts, including the benchmark Pt/C on Ni foam, in 1 M KOH in freshwater were further tested.

Unexpectedly, both the NiMoN@NiFeN and NiMoN catalysts exhibit exceptional HER activity (FIG. 3d) that is even better than that of the benchmark Pt/C catalyst, especially the NiMoN catalyst, which requires very low overpotentials of 56 and 127 mV for current densities of 100 and 500 mA cm⁻², respectively. The overpotentials to achieve the same current densities by embodiments of the NiMoN@NiFeN catalyst (84 and 180 mV) are slightly higher, but superior to those needed for the Pt/C (96 and 252 mV) and NiFeN (205 and 299 mV) catalysts.

NiMoN has been demonstrated to be an efficient HER catalyst in alkaline media because of its excellent electronic conductivity and low adsorption free energy of H*. FIG. 3e reveals that the NiMoN catalyst also exhibits a much smaller Tafel slope of 45.6 mV dec⁻¹ in comparison to the other catalysts measured. Moreover, the NiMoN catalyst shows good stability at current densities of 100 and 500 mA cm⁻² over 48 h HER testing (FIG. 3f). Therefore, embodiments of the NiMoN@NiFeN and NiMoN catalysts disclosed herein are highly active and robust for OER and HER, respectively, during freshwater electrolysis in alkaline media.

The OER and HER activity in an alkaline simulated seawater electrolyte (1 M KOH+0.5 M NaCl) is further disclosed herein. As shown in FIG. 3g, the 3D core-shell NiMoN@NiFeN catalyst still performs outstanding catalytic activity, which requires overpotentials of 286 and 347 mV to achieve current densities of 100 and 500 mA cm⁻², respectively.

This performance is very close to that in the 1 M KOH electrolyte (FIG. 3g), suggesting selective OER in the alkaline adjusted salty water. Natural seawater and an alkaline natural seawater electrolyte (1 M KOH+Seawater), in which the OER activity of the NiMoN@NiFeN catalyst shows only slight decay as compared with that in the other two electrolytes (FIG. 3g).

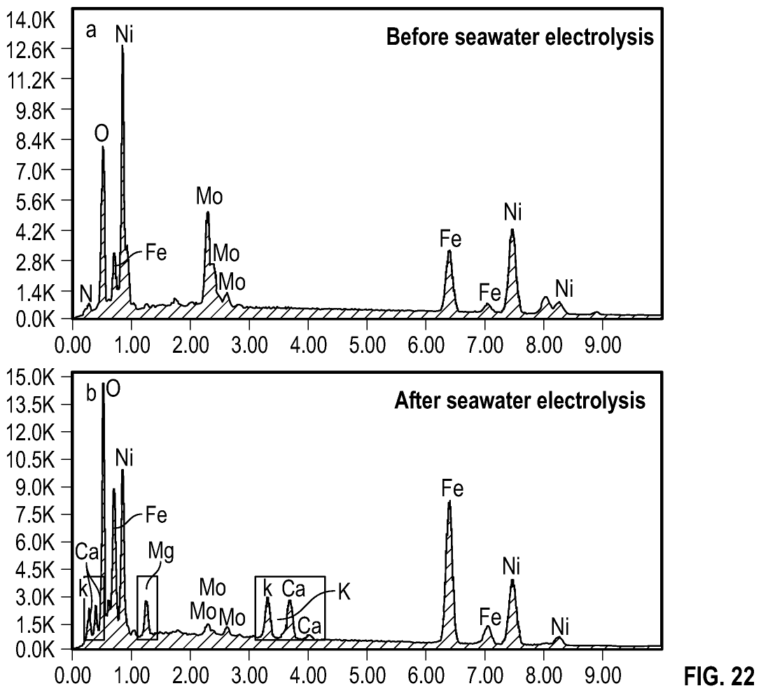

The slight decrease in activity may be due to some insoluble precipitates [e.g., Mg(OH)₂ and Ca(OH)₂] covering the surface of the electrode, and thus burying some surface active sites (FIGS. 21 and 22). Even so, the NiMoN@NiFeN catalyst still delivers current densities of 100 and 500 mA cm⁻² at small overpotentials of 307 and 369 mV, respectively, in the alkaline natural seawater electrolyte (FIG. 3h).

In addition, at an even larger current density of 1000 mA cm⁻², the demanded overpotential is only 398 mV, which is well below the 490 mV overpotential required to trigger chloride oxidation to hypochlorite. Moreover, this overpotential is also much lower than that of any of the other reported non-precious OER catalysts in alkaline adjusted salty water (Table 2). For the HER catalyst of NiMoN: it also exhibits excellent activity in both the alkaline simulated and natural seawater electrolytes (FIG. 3g). To deliver current densities of 100, 500, and 1000 mA cm⁻² in the alkaline natural seawater, the required overpotentials are as low as 82, 160, and 218 mV, respectively. Consequently, embodiments of NiMoN@NiFeN and NiMoN catalysts disclosed herein are not only efficient for freshwater electrolysis, but also highly active for alkaline seawater splitting.

### Overall Seawater Splitting:

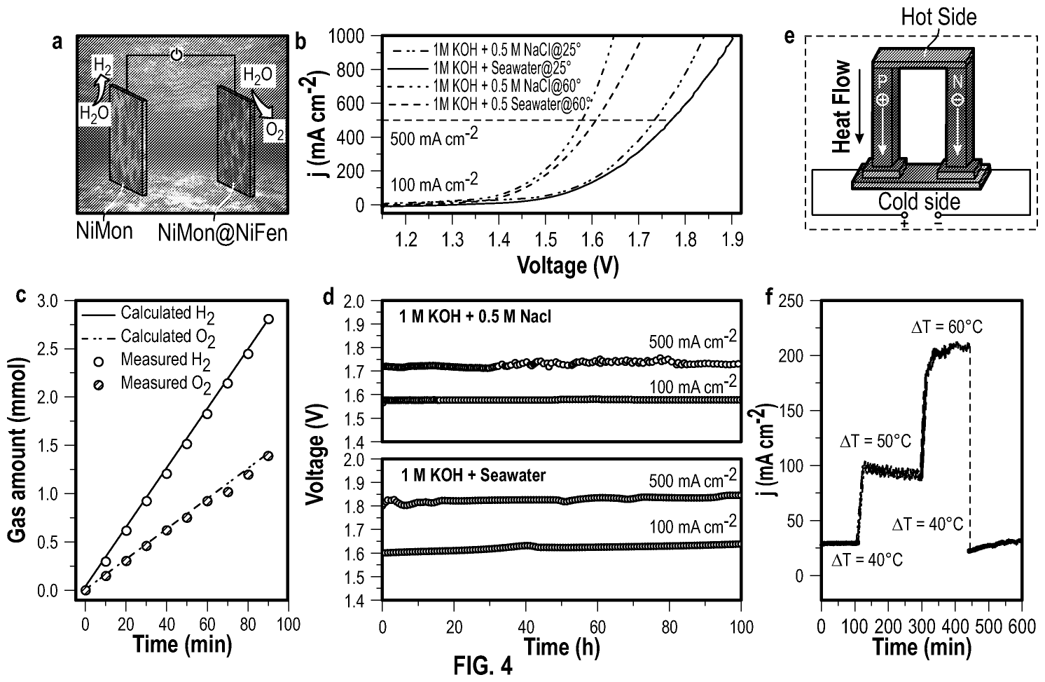

Considering the unexpectedly good catalytic performance of both the NiMoN@NiFeN and NiMoN catalysts, the overall seawater splitting performance was further investigated by integrating the two catalysts into a two-electrode electrolyzer, where the NiMoN@NiFeN is used as the anode for OER and NiMoN as the cathode for HER (FIG. 4a). Remarkably, this electrolyzer shows very effective overall seawater splitting activity in both the alkaline simulated and natural seawater electrolytes.

As displayed in FIG. 4b, at room temperature (25° C.), the cell voltages needed to produce a current density of 100 mA cm⁻² are as low as 1.564 and 1.615 V in 1 M KOH+0.5 M NaCl and 1 M KOH+Seawater electrolytes, respectively. In particular, embodiments of an electrolyzer as disclosed herein can generate extremely large current densities of 500 and 1000 mA cm⁻² at 1.735 and 1.841 V, respectively, in 1 M KOH+0.5 M NaCl electrolyte. Even in the alkaline natural seawater, the cell voltages for the corresponding current densities are only 1.814 and 1.901 V. This performance is better than that of most non-noble metal catalysts for freshwater splitting, as well as that of the benchmark of the Pt/C and IrO₂ catalysts in 1 M KOH.

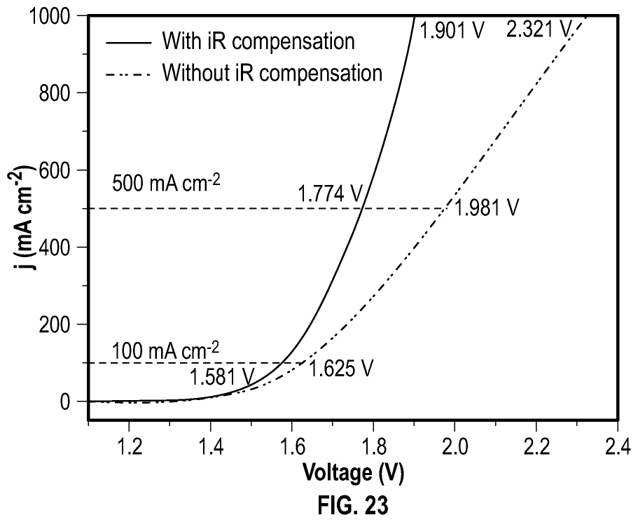

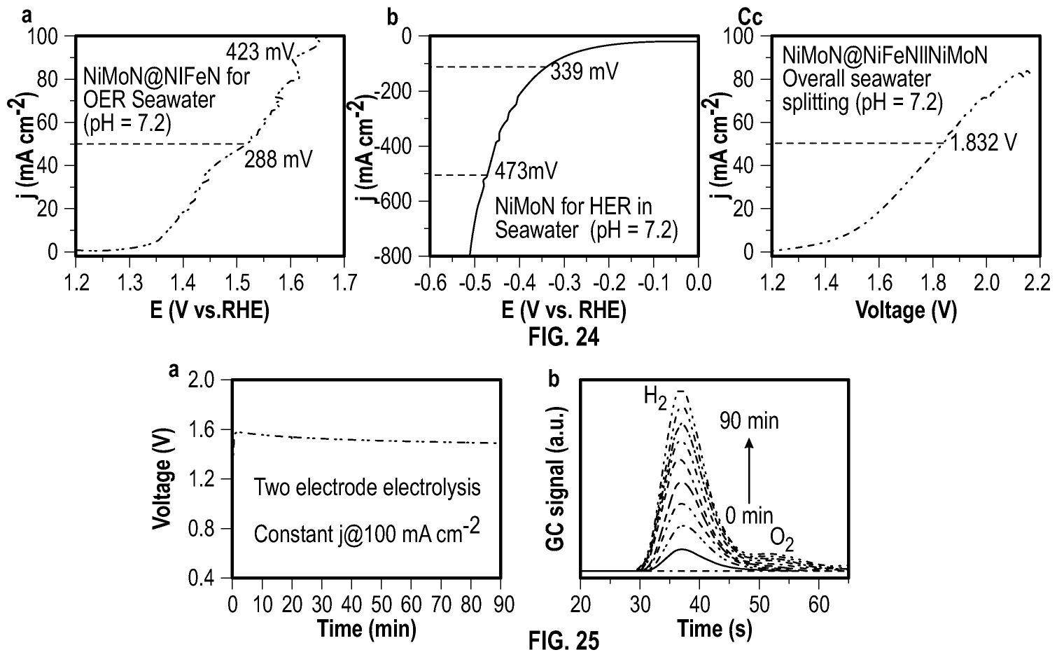

To boost the industrial applications of this electrolyzer, the cell voltages are further decreased to 1.454, 1.608, and 1.709 V for current densities of 100, 500, and 1000 mA cm⁻², respectively, in 1 M KOH+seawater electrolyte by heating the electrolyte to 60° C. that can be easily achieved by combining solar thermal hot water system. These values represent the current record-high performance indices for overall alkaline seawater splitting. The overall seawater splitting performance without iR compensation was also tested in 1 M KOH+Seawater at 25° C. for comparison (FIG. 23), and was found to be worse than that with IR compensation. A further attempted was made to split pure natural seawater, but the performance was unsatisfactory due to the low ionic conductivity and strong corrosiveness of the natural seawater (FIG. 24).

The Faradaic efficiency of the electrolyzer in 1 M KOH+0.5 M NaCl at room temperature was analyzed by collecting the evolved gaseous products over the cathode and anode (FIG. 25). As shown in FIG. 4c, only H₂ and O₂ gases with a molar ratio close to 2:1 are detected, and the Faradaic efficiency is determined to be around 97.8% during seawater electrolysis, demonstrating the high selectivity of OER on the anode.

In some embodiments, the operating durability is also used to assess the performance of an electrolyzer. As shown in FIG. 4d, the electrolyzer can retain an outstanding overall seawater splitting performance with no noticeable degradation over 100 h operation at a constant current density of 100 mA cm⁻² in both the alkaline simulated and natural seawater electrolytes.

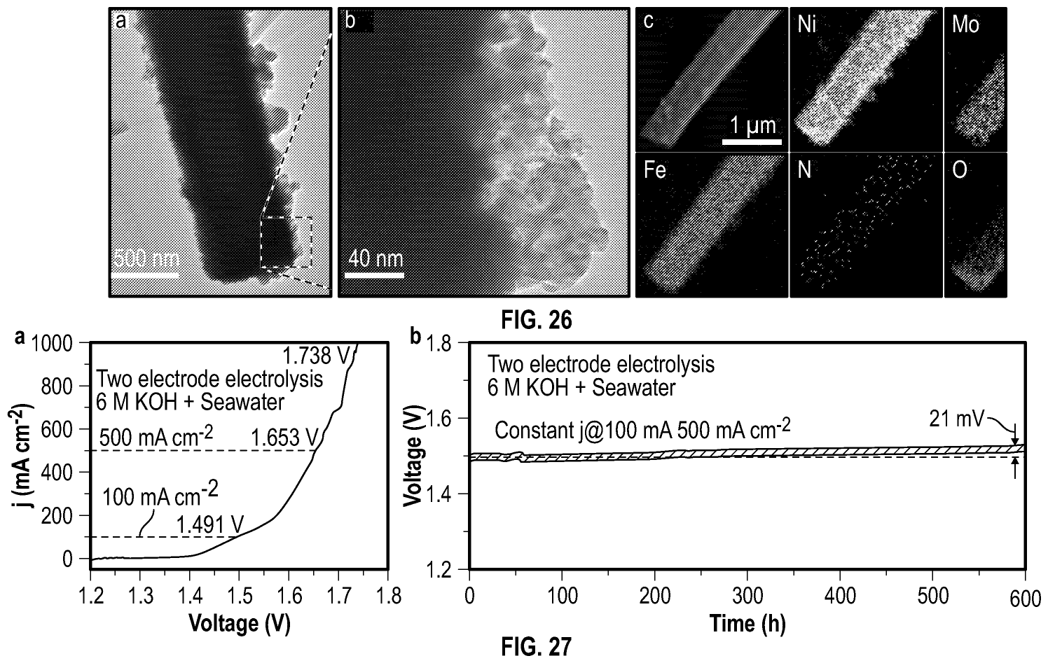

Further, in some embodiments the voltage needed to achieve a very large current density of 500 mA cm⁻² also shows no significant increase during 100 h water electrolysis in either of the two electrolytes (FIG. 4d), verifying the superior durability of this electrolyzer. The anode of the NiMoN@NiFeN catalyst further demonstrates good structural integrity after long-term seawater electrolysis (FIG. 26). In addition, the electrolyzer exhibits very good activity and stability (over 600 h electrolysis) for overall seawater splitting in a very harsh condition of 6 M KOH+Seawater (FIG. 27), demonstrating its great potential for large-scale applications.

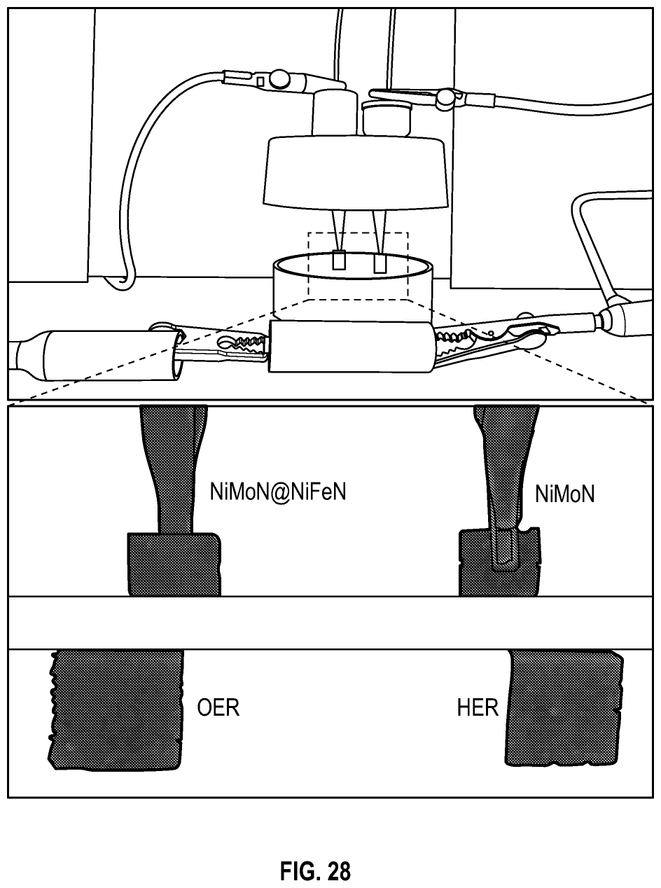

Given its superior catalytic performance, this electrolyzer can be easily actuated by a 1.5 V AA battery (FIG. 28). Moreover, it was also demonstrated to harvest waste heat (the major energy loss in various activities and device operations) by embodiments of the seawater electrolyzer disclosed herein which are powered with a commercial thermoelectric (TE) device that directly coverts heat into electricity (FIG. 4e).

As shown in FIG. 4f, when the temperature gradient between the hot and cold sides of the TE module is 40, 50, and 60° C., the corresponding output voltage can expeditiously drive the electrolyzer for stable delivery of current density of 30, 100, and 200 mA cm⁻², respectively.

Even when the temperature gradient through the TE module is decreased to 40° C., the electrolyzer can still supply a current density of ˜30 mA cm⁻² with good recyclability, indicating that it may efficiently convert the waste heat to produce H₂ fuel by electrolysis of seawater.

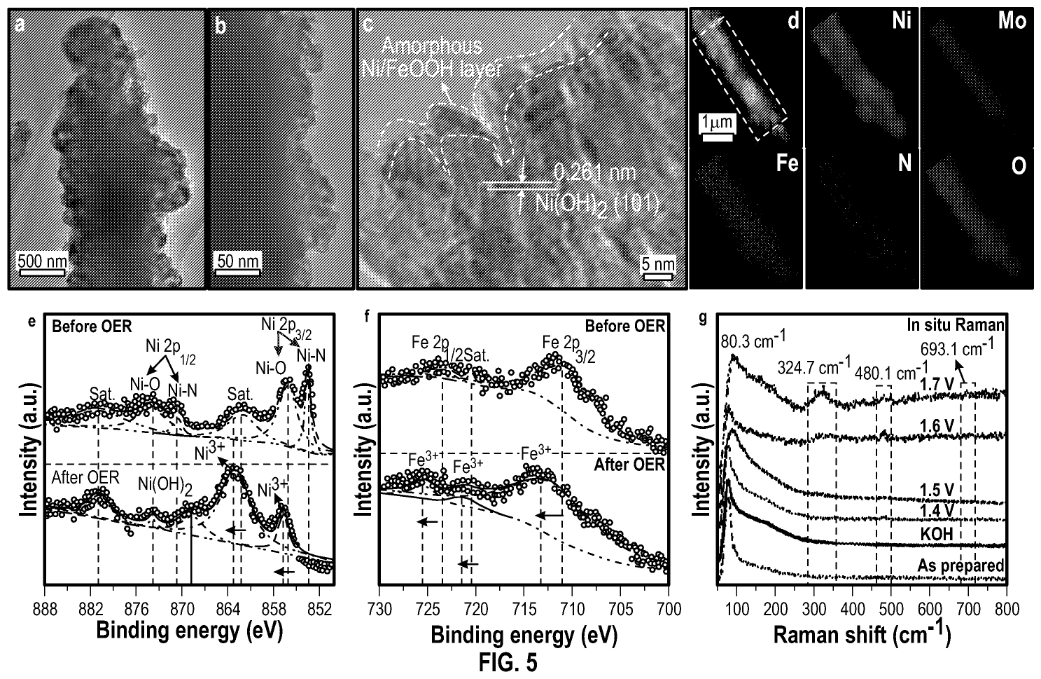

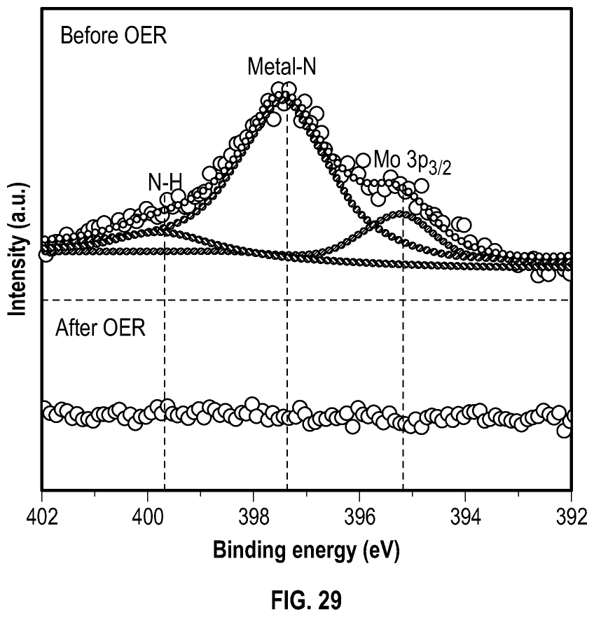

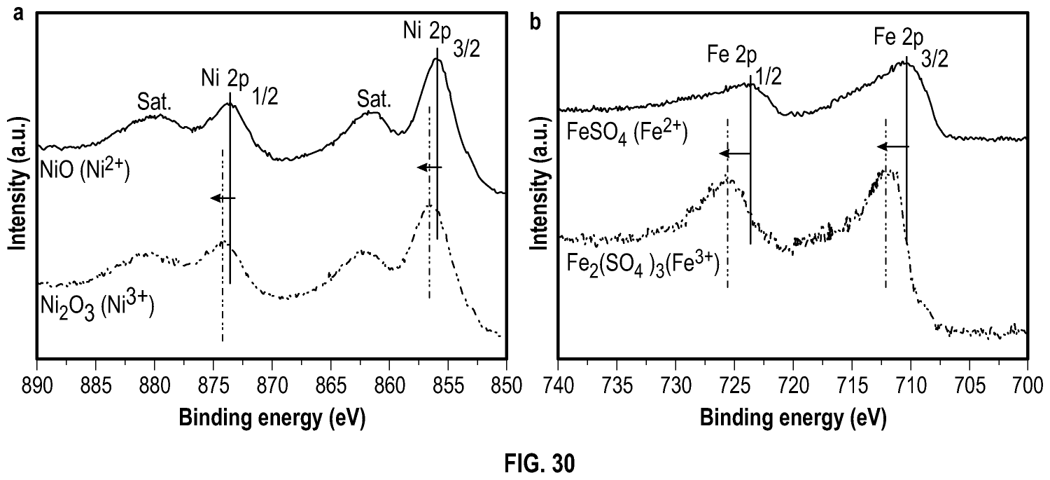

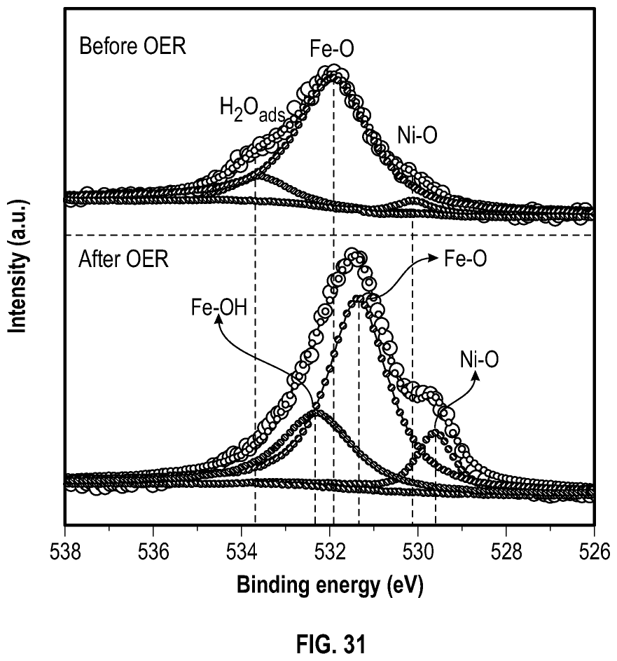

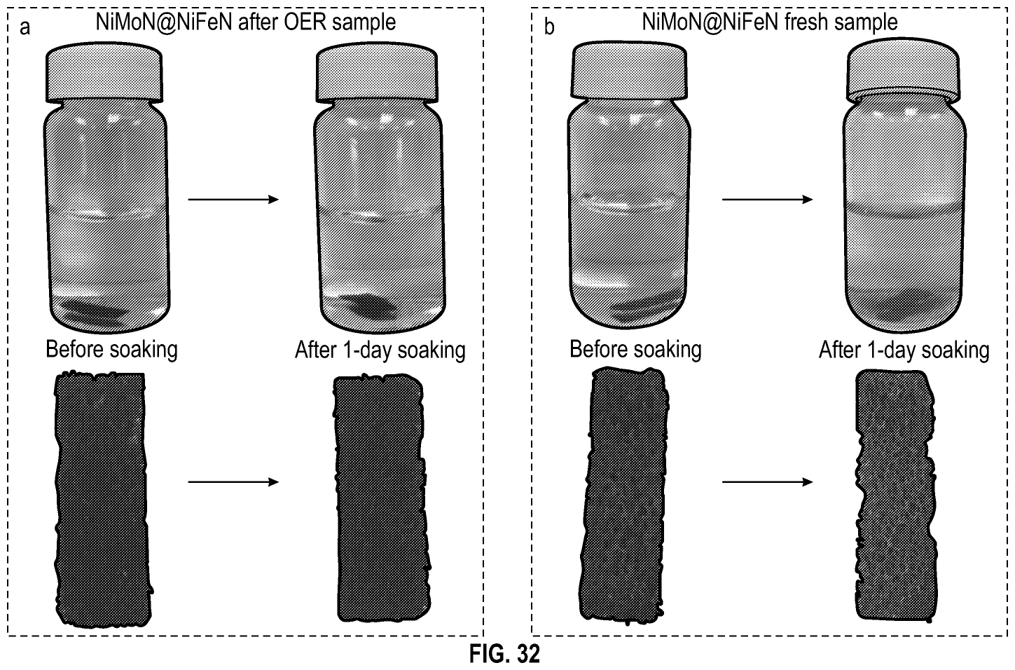

To gain deeper insight into the real catalytic active sites for the unexpectedly improved OER activity of the NiMoN@NiFeN catalyst, the nanostructure, surface composition, and chemical state after OER tests were further studied. The TEM image in FIG. 5a shows that the 3D core-shell nanostructure of NiMoN@NiFeN is intact after OER tests, which is consistent with the SEM results (FIG. 16). The TEM image in FIG. 5b reveals that many nanoparticles are closely attached on the nanorod, and there seems to be some very thin layers on the nanoparticle surface. The HRTEM image in FIG. 5c confirms the existence of thin amorphous layers and Ni(OH)₂. It is thus suspected that the thin layers are in-situ generated amorphous NiFe oxides and NiFe oxy(hydroxides), which have been verified by elemental mapping and XPS analyses following OER testing. FIG. 5d displays the DF-STEM and corresponding elemental mapping images, which show the absence of N and the increased O content on the NiMoN@NiFeN surface after OER due to the intense oxidation process. The high-resolution XPS of N 1s (FIG. 29) also corroborates this point. For the high-resolution XPS of Ni 2p (FIG. 5e), the two peaks attributed to Ni—N species at 853.4 and 870.8 eV also disappear after OER because of surface oxidation. A new peak at 868.9 eV, which is assigned to Ni(OH)₂, shows up. Besides, the two peaks at 856.3 (Ni—O) and 862.0 eV (Sat.) positively shift toward higher binding energy, which is also observed in the XPS of Fe 2p (FIG. 5f), indicating the oxidation of Ni²⁺ and Fe²⁺ to the higher valence states of Ni³⁺ and Fe³⁺ (FIG. 30), respectively, resulting from the formation of NiFe oxides/oxy(hydroxides). The O 1s XPS (FIG. 31) also proves the increased valence states of Ni²⁺ and Fe²⁺ after OER, as well as showing the appearance of Fe—OH from the NiFe oxy(hydroxides), which can be seen from the negative shift of the main peaks at 531.9 and 530.1 eV and the appearance of a new peak at 532.3 eV.⁴⁹ To confirm the formation of NiFe oxides/oxy(hydroxides), we further performed in situ Raman measurements to elucidate the real-time evolution of the NiMoN@NiFeN catalyst during the OER process. As the results in FIG. 5g show, the spectrum for the as-prepared NiMoN@NiFeN exhibits a sharp and broad peak at around 80.3 cm⁻¹, which is probably due to the metal-N stretching modes. The transformation into NiOOH starts at 1.4 V according to a new Raman band located at 480.1 cm⁻¹, When the potential reaches to 1.6 and 1.7 V, two additional Raman bands are generated. The one located at 324.7 cm⁻¹ is assigned to the Fe—O vibrations in Fe₂O₃, and the other at 693.1 cm⁻¹ belongs to the Fe—O vibrations in amorphous FeOOH. Therefore, by combining these results with the XPS results, we conclude that thin amorphous layers of NiFe oxide and NiFe oxy(hydroxide) are evolved from the NiFeN nanoparticles at the surface during OER electrocatalysis, and that these serve as the real active sites participating in the OER process. This observation is consistent with the results of other reported OER catalysts, including metal selenides and phosphides. What's more, such in-situ generated amorphous NiFe oxide and NiFe oxy(hydroxide) layers also play a positive role in improving the resistance to corrosion by chloride anions in seawater (FIG. 32), which contributes to the superior stability during seawater electrolysis. Conclusions: In summary, herein a 3D core-shell OER catalyst of NiMoN@NiFeN for active and stable seawater splitting has thus been developed. The interior NiMoN nanorods are highly conductive and afford a large surface area, which ensure efficient charge transfer and numerous active sites. The outside decorated NiFeN nanoparticles in-situ evolve thin amorphous layers of NiFe oxide and NiFe oxy(hydroxide) during OER catalysis, which are not only responsible for the selective OER activity, but also beneficial for the corrosion resistance to chloride anions in seawater. At the same time, the 3D core-shell nanostructures with multiple levels of porosity are favorable for seawater diffusion and gaseous product releasing. Thus, this OER catalyst requires very low overpotentials of 369 and 398 mV to deliver large current densities of 500 and 1000 mA cm⁻² in alkaline natural seawater at 25° C. Especially, by pairing it with another efficient HER catalyst of NiMoN, an outstanding water electrolyzer for overall seawater splitting is disclosed herein, which outputs current densities of 500 and 1000 mA cm⁻² at record low voltages of 1.608 and 1.709 V, respectively, in alkaline natural seawater at 60° C. The electrolyzer also shows excellent durability with no obvious activity loss at current densities of 100 and 500 mA cm⁻² during up to 100 h seawater electrolysis. This discovery developed a robust and active catalyst to utilize the world's abundant seawater feedstock for large-scale hydrogen production by renewable energy sources.

### Examples

Experimental Section: Chemicals. Ethanol (C₂H₅OH, Decon Labs, Inc.), ammonium heptmolybdate [(NH₄)₆Mo₇O₂₄.4H₂O, 98%, Sigma-Aldrich], nickel(II) nitrate hexahydrate (Ni(NO₃)₂.6H₂O, 98%, Sigma-Aldrich), iron (III) nitrate hexahydrate (Fe(NO₃)₃.9H₂O, 98%, Sigma-Aldrich), N, N Dimethylformamide [DMF, (CH₃)₂NC(O)H, anhydrous, 99.8%, Sigma-Aldrich], platinum powder (Pt, nominally 20% on carbon black, Alfa Aesar), iridium oxide powder (IrO₂, 99%, Alfa Aesar), Nafion (117 solution, 5% wt, Sigma-Aldrich), sodium chloride (NaCl, Fisher Chemical) potassium hydroxide (KOH, 50% w/v, Alfa Aesar), and Ni foam (thickness: 1.6 mm) were used as received. Deionized (DI) water (resistivity: 18.3 MΩ·cm) was used for the preparation of all aqueous solutions.

Synthesis of NiMoO₄ nanorods on Ni foam: In some embodiments NiMoO4 nanorods were synthesized on nickel foam through a hydrothermal method, wherein a piece of commercial Ni foam (2×5 cm²) was cleaned by ultrasonication with ethanol and DI water for several minutes, and the substrate was then transferred into a polyphenyl (PPL)-lined stainless-steel autoclave (100 ml) containing a homogenous solution of Ni(NO₃)₂.6H₂O (0.04 M) and (NH₄)6Mo₇O₂₄.4H₂O (0.01 M) in 50 ml H₂O. Afterward, the autoclave was sealed and maintained at 150° C. for 6 h. The sample was then taken out and washed with DI water and ethanol several times before being fully dried at 60° C. overnight under vacuum.

Synthesis of NiMoN nanorods and NiMoN@NiFeN core-shell nanorods: In some embodiments metal nitrides were synthesized by a one-step nitridation of the NiMoO₄ nanorods in a tube furnace. For the synthesis of NiMoN nanorods, a piece of NiMoO₄/Ni foam (˜1 cm²) was placed at the middle of a tube furnace and thermal nitridation was conducted at 500° C. under a flow of 120 standard cubic centimeters (sccm) NH₃ and 30 sccm Ar for 1 h. The furnace was then automatically turned off and naturally cooled down to room temperature under Ar atmosphere.

For the synthesis of NiMoN@NiFeN core-shell nanorods, in some embodiments a piece of NiMoO₄/Ni foam (˜1 cm²) was first soaked into a NiFe precursor ink, which was prepared by dissolving Ni(NO₃)₂.6H₂O and Fe(NO₃)₃.9H₂O with mole ratio of 1:1 in DMF, then the NiMoO₄/Ni foam coated with the NiFe precursor ink was dried at ambient condition. The dried sample then underwent thermal nitridation under the same conditions as for NiMoN.

To study the effect of the loading amount of NiFeN on the morphology of the core-shell nanorods, four different NiMoN@NiFeN core-shell nanorods with different loading amounts of NiFeN were formed by controlling the concentration of Ni and Fe precursors as prepared herein, and in some embodiments 0.1 g ml⁻¹, 0.25 g ml⁻¹, 0.5 g ml⁻¹, and 0.75 g ml⁻¹ concentrations of precursor ink were used.

For comparison, pure NiFeN nanoparticles were also prepared on the Ni foam by replacing the NiMoO₄/Ni foam with Ni foam. The concentration of precursor ink in this case was 0.25 g ml⁻¹, and all other synthesis conditions were the same as for NiMoN@NiFeN. Preparation of IrO₂ and Pt/C catalyst on Ni foam. To prepare the IrO₂ electrode for comparison, 240 mg of IrO₂ and 60 μL of Nafion were dispersed in 540 μL of ethanol and 400 μL of DI water, and the mixture was ultrasonicated for 30 min. The dispersion was then coated onto a Ni foam substrate, which was dried in air overnight. Pt/C electrodes were obtained by the same method.

### Materials Characterization:

The morphology and nanostructure of the samples were detected by scanning electron microscopy (SEM, LEO 1525) and transmission electron microscopy (TEM, JEOL 2010F) coupled with energy dispersive X-ray (EDX) spectroscopy. The phase composition of the samples was characterized by X-ray diffraction (PANalytical X'pert PRO diffractometer with a Cu Ka radiation source) and X-ray photoelectron spectroscopy (XPS) (PHI Quantera XPS) using a PHI Quantera SXM scanning X-ray microprobe. Electrochemical tests. The electrochemical performance was tested on an electrochemical station (Gamry, Reference 600). In some embodiments, the two half reactions of oxygen evolution reaction (OER) and hydrogen evolution reaction (HER) were each carried out at room temperature (˜25° C.) in a standard three-electrode system with embodiments of prepared sample as the working electrode, a graphite rod as the counter electrode, and a standard Hg/HgO electrode as the reference electrode. Four different electrolytes, including 1 M KOH, 1 M KOH+0.5 M NaCl, 1 M KOH+Seawater, and natural seawater, were used, and the pH was around 14 except for the natural seawater (pH ˜7.2).

In some embodiments, both the anodes (NiMoN@NiFeN) and cathodes (NiMoN) were cycled ˜100 times by cyclic voltammetry (CV) until a stable polarization curve was developed prior to measuring each polarization curve. OER and HER polarization curve measurements were performed with a sweep rate of 2 mV s−1 and stability tests were carried out under constant overpotentials.

Electrochemical impedance spectra (EIS) were measured at an overpotential of 150 mV from 0.1 Hz to 100 KHz with an amplitude of 10 mV. For the two-electrode seawater electrolysis, the as-prepared NiMoN@NiFeN and NiMoN catalysts (after CV activation) were used as the anode and cathode, respectively. The polarization curves were collected in different electrolytes at different temperatures (25 and 60° C.), and stability tests were carried out under constant current densities of 100 and 500 mA cm⁻² at room temperature.

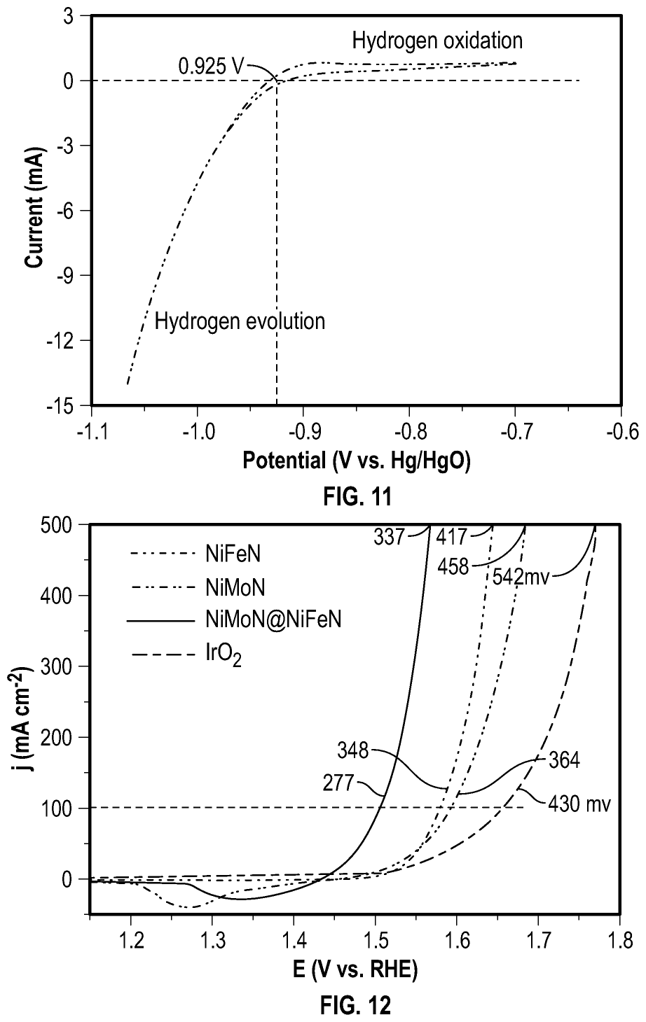

All of the measured potentials vs. Hg/HgO were converted to the reversible hydrogen electrode (RHE) according to the reference electrode calibration (FIG. 11, E_{RHE}=E_{Hg/HgO}+0.925). All curves were reported with iR compensation (85%). Gas chromatography measurement. Overall seawater splitting for gas chromatography (GC, GOW-MAC 350 TCD) tests were performed in a gas-tight electrochemical cell with 1 M KOH+0.5 M NaCl as the electrolyte at room temperature (25° C.). Chronopotentiometry was applied with a constant current density of 100 mA cm⁻² to maintain oxygen and hydrogen generation. For each measurement over an interval of 10 min, a 0.3 μL gas sample was carefully extracted from the sealed cell and injected into the GC instrument using a glass syringe (Hamilton Gastight 1002). Overall seawater splitting driven by a thermoelectric module.

A commercial thermoelectric (TE) module was used as a power generator to drive embodiments of two-electrode electrolyzer. During the test, the hot side of the TE module was covered by a large flat copper plate, which was in direct contact with a heater on top. The hot-side temperature was maintained relatively constant by tuning the DC power supply to the heater, while the cold-side temperature was controlled by placing it in direct contact with a cooling system, where the water inside was adjusted to remain at a constant temperature. Thus, the TE module generated a relatively stable open circuit voltage between the hot and cold sides. A nano-voltmeter and an ammeter were embedded into the circuit for real-time monitoring of the voltage and current between the two electrodes of the water-splitting cell.

The surface morphology of the NiMoN@NiFeN core-shell nanorods changes greatly upon varying the concentration of NiFe precursors, which determines the loading amount of NiFeN nanoparticles.

Four different NiMoN@NiFeN samples were prepared under embodiments herein disclosed wherein precursor ink concentrations of 0.1, 0.25, 0.5, and 0.75 g ml⁻¹, and the corresponding loading mass values of NiFeN nanoparticles were 0.84, 1.27, 1.88, and 2.33 g cm⁻², respectively.

In some embodiments, with a precursor ink concentration of 0.1 g ml⁻¹, some NiFeN nanoparticles are randomly interspersed on the surfaces of the NiMoN nanorods (FIG. 10 (a1-a3)); in other embodiments, when the concentration is 0.25 g ml⁻¹, the entire surfaces of the NiMoN nanorods are uniformly decorated with many NiFeN nanoparticles (FIG. 10 (b1-b3)), and the large interspace between the neighboring nanorods is well preserved, thus maximizing the active surface area with different levels of porosity; in a still further embodiment, the precursor ink concentration is increased to 0.5 g ml⁻¹, and the nanoparticles are aggregated on the NiMoN surfaces as well as in the interspaces between the nanorods.

When the concentration is further increased to 0.75 g ml⁻¹, the NiMoN nanorods are almost buried, and the interspaces between the nanosheets are completely filled with the NiFeN nanoparticles, thereby reducing the surface area. Therefore, the optimized concentration of precursor ink is 0.25 g ml⁻¹·f

Table 1 provides an OER activity comparison between the NiMoN@NiFeN catalyst and other reported non-noble metal electrocatalysts in 1 M KOH at room temperature. Here η₁₀₀ and η₁₀₀ correspond to the overpotentials at current densities of 100 and 500 mA cm⁻², respectively, wherein* indicates that the value is calculated from the curves shown in the literatures.

| | | η100 | η500 | |
|---|---|---|---|---|
| Catalyst | Support | (mV) | (mV) | Reference |
| NiMoN@NiFeN | Ni foam | 277 | 337 | Disclosed herein. |
| Zn_{0.2}Co_{0.8}OOH | Glassy carbon | 290* | NA | Nat. Energy 2019, |
| | | | | DOI: org/10.1038/s41560-019-0355-9 |
| Se-doped FeOOH | Fe foam | 279 | 348 | J. Am. Chem. Soc. 2019, 141, 7005 |
| NiCoFe—MOF | Ni foam | 310* | NA | Adv. Mater. 2019, |
| | | | | DOE: 10.1002/adma.201901139 |
| FeNiP/NCH | glassy carbon | 340* | NA | J. Am. Chem. Soc. 2019, 141, 7906 |
| NiFeV | Carbon paper | 264 | 291 | Nat. Common. 2018, 9, 2885 |
| FeₓCo₁₋ₓOOH | Ni foam | 300* | NA | Angew. Chem. Int. Ed. 2018, 57, 1 |
| Co—Ni₃N | Carbon cloth | 385* | NA | Adv. Mater. 2018, 30, 1705516 |
| NiFe LDH/ | Glassy carbon | 325* | NA | Adv. Mater. 2017, 29, 1700017 |
| graphene | | | | |
| FeCoW | Au foam | 253* | NA | Science 2016, 352, 333 |
| NiFe LDH | Ni foam | 450* | NA | Science 2014, 345, 1593 |

TABLE 2
OER activity comparison between the NiMoN@NiFeN catalyst and other
reported non-noble metal electrocatalysts in different alkaline simulated
and natural seawater, and neutral electrolytes at room temperature.

| Catalyst | Electrolyte | j (mA cm²) | η (mV) | Reference |
|---|---|---|---|---|
| NiMoN@NiFeN | 1 M KOH + | 100 | 286 | Disclosed herein |
| | 0.5 NaC1 | 500 | 347 | |
| | | 1,000 | 377 | |
| | 1 M KOH + | 100 | 307 | |
| | Seawater | 500 | 369 | |
| | | 1,000 | 398 | |
| NiFe/NiSx—Ni | 1 M KOH + | 400 | ~300 | Proc. Natl Acad. Sci. USA |
| | 0.5 NaC1 | 1,500 | ~300 | 2019, 116, 6624 |
| NiFe LDH | 0.1 M KOH + | 10 | 359 | ChemSusChem 2016, 9, |
| | 0.5 NaC1 | | | 962 |
| | 0.3 M Borate | 10 | 490 | |
| | buffer + 0.5 | | | |
| | NaC1 | | | |
| Metal | 1 M Phosphate | 48.5 | ~570 | Adv. Mater. 2018, 30, |
| hexacyano- | buffer | | | 1707261 |
| metallates | | | | |
| Fe-based film | 0.1 M Phosphate | 5 | ~565 | Angew. Chem. Int. Ed. |
| | buffer | | | 2015, 54, 4870 |
| Co phosphate | 1 M Phosphate | 100 | 442 | Energy Enviorn. Sci. 2011, |
| and borate | buffer | | | 4, 499 |
| | 1 M Borate | 100 | 363 | |
| | buffer | | | |

Therefore, disclosed herein are embodiments of a three-dimensional core-shell transition metal-nitride (TMN) catalyst and methods of making such three-dimensional core-shell transition metal-nitride (TMN) catalysts, wherein said catalyst functions as effective and efficient oxygen evolution reaction catalyst for alkaline seawater electrolysis.

1. A three-dimensional core-shell transition metal-nitride (TMN) catalyst comprising:
a porous Ni foam support,
nanorods comprising a first transition metal-nitride (TMN) material positioned on said porous Ni foam support; and
nanoparticles comprising a second transition metal-nitride (TMN) material positioned on said nanorods wherein said catalyst functions as an oxygen evolution reaction catalyst.

2. The catalyst of claim 1, wherein said catalyst catalyzes alkaline seawater electrolysis.

3. The catalyst of claim 1, wherein said first transition metal-nitride (TMN) material is Ni₃N/Ni, NiMoN, NiFeN, NiCoN, CoFeN or a combination thereof.

4. The catalyst of claim 1, wherein said nanorods comprises Ni₃N/Ni, NiMoN, NiFeN, NiCoN, CoFeN or a combination thereof.

5. The catalyst of claim 1, wherein said nanorods comprises NiMoN.

6. The catalyst of claim 1, wherein said second transition metal-nitride (TMN) material is Ni₃N/Ni, NiMoN, NiFeN NiCoN, CoFeN or a combination thereof.

7. The catalyst of claim 1, wherein said nanorod comprises Ni₃N/Ni, NiMoN, NiFeN NiCoN, CoFeN or a combination thereof.

8. The catalyst of claim 1, wherein said nanoparticles comprise NiFeN.

9. The catalyst of claim 1, wherein said catalyst comprises current densities of about 500 to about 1000 mA cm⁻² at overpotentials of between 369 and 398 mV.

10. The catalyst of claim 1, further comprising a hydrogen evolution catalyst.

11. The catalyst of claim 1, wherein said catalyst comprises current densities of about 500 to about 1000 mA cm⁻² at about 1.6 V and about 1.7V.

12. The catalyst of claim 1, wherein said nanorods comprise mesopores.

13. The catalyst of claim 11, wherein the mesoporous pores are between 0.001 nm and 50 nm in diameter.

14. The catalyst of claim 12, wherein the mesopores comprise a surface roughness (Ra) of between 0.1 and 50.

15. The catalyst of claim 3, wherein the nanorods comprise a scaffold, and wherein said scaffold comprises active edge sites for OER.

16. A method of making a three-dimensional core-shell transition metal-nitride (TMN) catalyst comprising:
positioning a porous Ni foam support;
forming nanorods on said support;
soaking said nanorods in a precursor ink, and performing a nitridation of said nanorods to form a three-dimensional core-shell transition metal-nitride (TMN) catalyst, wherein said catalyst is a oxygen evolution reaction (OER) catalyst.

17. The method of claim 15, wherein said forming is by a hydrothermal method.

18. The method of claim 15, wherein said nanorods comprise NiMoN.

19. The method of claim 15, wherein said nanoparticles comprise NiFeN.

20. The catalyst of claim 1, wherein said catalyst comprises:
a porous Ni foam support,
NiMoN nanorods positioned on said porous Ni foam support; and
NiFeN nanoparticles positioned on said NiMoN nanorods, wherein said catalyst is a NiMoN@NiFeN catalyst, and wherein said catalyst functions as an oxygen evolution reaction catalyst (OER) for alkaline seawater electrolysis.
